(19) United States
(12) Patent Application Publication
(10) Pub. No.: US 2020/0155893 A1
(43) Pub. Date: May 21, 2020

(54) YOGA SYSTEM HAVING VIBRATING EXERCISE SURFACES AND METHODS OF MAKING AND USING THE SAME

(71) Applicant: Praying Mantis Yoga, LLC, Peachtree City, GA (US)

(72) Inventors: Jennifer Manley, Peachtree City, GA (US); Laura Lenox, Fayetteville, GA (US)

(21) Appl. No.: 16/435,542

(22) Filed: Jun. 9, 2019

Related U.S. Application Data
(63) Continuation of application No. PCT/US2017/065493, filed on Dec. 9, 2017.
(60) Provisional application No. 62/432,269, filed on Dec. 9, 2016.

(51) Int. Cl. A63B 21/00; A61H 23/04

(52) U.S. Cl. CPC A63B 21/4037; A61H 2201/5038; A61H 2201/0134; A61H 23/04

(57) ABSTRACT

A system and method for conducting an exercise or yoga on a moving or vibrating surface is described. Movement zones are designed and constructed within or upon a standard flooring system to provide vibration or motion that is used as an adjunct to exercise or the practice of yoga, pilates, mediation, and prayer.

This disclosure relates to a system for generating instabilities, e.g., vibrations in an exercise surface that is safe and comfortable. More specifically, this disclosure relates to a flooring system that comprises zones capable of motions upon which a user can exercise, practice yoga, pilates, engage in meditation or prayer, while improving balance and core muscles. Still more particularly, this disclosure relates to a system of built-in vibrating yoga mats that allow a user to adjust the type and level of vibration that will be used in conjunction with their exercise plan or yoga class. According to one embodiment, the disclosure also relates to methods for conducting yoga from atop a moving yoga mat. According to another method, the disclosure relates to methods for producing the flooring systems comprising moving exercise zones.

### BACKGROUND

The inclusion of vibration in systems to improve the development of core muscles has become more common in the past few years in both the fields of exercise and physical therapy. The use of vibration causes a level of instability requiring the muscles to work harder to maintain balance while performing an exercise or even just standing. Vibration is also known to improve oxygen and nutrient consumption by muscles thereby improving muscle regeneration and increase blood flow due to capillary dilation. Vibration systems have taken a variety of shapes including everything from old fashioned belt vibrators, to chair massagers, back or stick massagers, and vibration platforms.

Traditionally, vibration platforms are pieces of gym equipment that include a base containing a vibration generator, e.g., a vibrating motor, a handrail, and a control panel. The user steps up onto the base and grasps the handrail that is attached to the base and uses the control panel to begin the platform vibrating. The user can then perform simple exercises, for example, standing on one foot, or the user can stand on both feet allowing the vibrations to develop their balance.

Such a system is taught, for example, in U.S. Published patent application 2011/0294635 to Morris. The system described in Morris is an exercise platform that includes a vibration motor. Morris claims to improve over prior vibration platforms as his platform has less lateral vibrations and more direct lifting and lowering making it easier to use. That system, like other prior art systems, suffers from the disadvantages that it is too small to carry out any exercise in which the user is not essentially upright. Further, users have a greater potential for getting injured if they fail to keep their balance on the platform as there is a substantial distance between the platform and the floor, Finally, while the vibration pattern may be easier to use in Morris's system, there is no substantial control of the type of movement that the vibration platform makes.

The instant disclosure overcomes the disadvantages of the vibration platforms by placing the vibration generator, or other motion generator, below the floor and making at least a portion of the floor non-stationary to accept the movements from a motion generator. Hereafter, the area of the floor that accepts motions will be referred to as the “movement zone” and the vibrator or other pattern generator will be referred to as “motion generators.” Keeping the movement zone substantially co-planar with the floor allows a user to carry out yoga or an exercise routine where all, or some of their body, contacts the movement zone. In this way, vibrations or other motions may be added to the exercise or yoga program in ways that a vibration platform could never be used.

According to one embodiment the system is an exercise floor having movement zones that may be sized and shaped like yoga mats. According to another embodiment, the system is a flooring system including movement zones that may be substantially coplanar with the exercise floor. According to yet another embodiment, the system comprises movement zones that are below the floor surface and are exposed by retracting, removing or disassembling the floor. In yet another embodiment, the system is a group of vibration platforms that have a low profile and are sized and shaped like yoga mats, that can be used alone or in combination by a user.

### SUMMARY

The present disclosure describes systems for exercising, comprising, an exercise surface having a movement zone, wherein the movement zone is cooperative with the exercise surface. The movement zone is generally sized to allow a person to exercise in any standing, sitting or lying position and is generally sized like a yoga mat.

The movement zone is generally under or coplanar with the floor, but may be raised or a separate unit upon the floor if the height profile does not interfere with the user ability to use the surface in the manner intended.

The present disclosure further describes systems and methods for generating movements in the movement zones that can be controlled by a user. More particularly, the user will have access to a controller that can allow them to use some or all of the available features of the particular movement zone they are using. Still more particularly, the disclosure describes different motion generators for generating vibrations or other patterns of movement. One or more motion generators may be used in any movement zone configuration.

The present disclosure further describes a system for exercising, comprising an exercise surface that may be modulated, or floated, to create an unstable surface upon which a user can exercise. More particularly the surface may overly a system of air balloons that may be filled and released to create motion effects in the movement zone.

The present disclosure also describes a method for generating a pattern of movement in an exercise surface allowing a user to exercise, practice yoga or pilates, or engage in meditation or prayer while improving balance and core muscles.

A better understanding of the various disclosed system and method embodiments can be obtained when the following detailed description is considered in conjunction with the drawings.

### BRIEF DESCRIPTION OF THE DRAWINGS

FIG. 1 illustrates a top plan view of one embodiment of the flooring system and movement zone according to the present disclosure.

FIG. 2 illustrates a perspective view of one embodiment of the flooring system and movement zone according to the present disclosure.

FIG. 3 illustrates a cut-away view of one embodiment of the flooring system and movement zone according to the present disclosure.

FIG. 4 illustrates a cut-away view of another embodiment of the flooring system and movement zone according to the present disclosure.

FIG. 5 is an exploded view of one embodiment of a movement zone within a flooring system.

FIG. 6 illustrates a movement zone within a flooring system with an embedded control panel

FIGS. 7A to 7D illustrate a cut-away view of the movement zone from the embodiment as seen in FIG, 5,

FIG. 8 illustrates one embodiment of a control system for the compressor and controller 108 as seen in FIG. 5.

FIG. 9 illustrates one embodiment where the movements are generated by compressed air.

FIG. 10 illustrates an compressed air actuator and control system for controlling the motion in the movement zone.

### DETAILED DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function.

In the following discussion and in the claims, the terms “including,” “comprising” and “is” are used in an open-ended fashion, and thus should be interpreted to mean “including, but not limited to. The use of positional indicators, e.g., on “over,” “top,” “bottom,” “front,” and “back,” and variations of those terms are made for convenience, and unless specified they are merely representative of an embodiment and do not limit the particular orientation of components.

As used herein “exercise surface,” “exercise floor,” and “floor,” are all used interchangeably and refer to a base surface that is integrated with movement zones upon which exercise, yoga, pilates, meditation, therapy or other physical activity can be conducted. Such surfaces can include but are not limited to, a studio floor, a gymnasium floor, a locker room floor, a raised dais upon which an exercise class might be conducted, the floor or an in-home exercise studio, and the like.

As used herein “vibration,” “movement,” “motion, and modulation” all refer to motions that may occur in the exercise surface. It should be understood that embodiments described with reference to one type of motion, e.g., vibration, may also be used with an alternative motion, e.g. air pockets, or combinations thererof.

As used herein “sized and shaped like a yoga mat” defines an area that a typical person would engage on the floor during exercise. Yoga mats are sold in everything from short 2 feet by 4 feet sizes to larger surfaces that would allow a typical person to lie prone, for example, 2.5 feet wide by 6 feet long. The movement zone as described herein can take any desired shape and can be sized to accommodate the desired orientation of the user. In a smaller embodiment, the movement zone may be, for example, 2 feet by 2 feet to allow a user to exercise in a standing position. In another embodiment, the movement zone could be 2.5 feet by 3.5 feet to allow a user to exercise while sitting. In a larger embodiment, the movement zone could be 3 feet by 6 feet to allow a larger person to exercise prone. In yet a larger embodiment, the movement zone could be 6 feet by 6 feet allowing more than one user to be located in the same movement zone.

According to one embodiment, the movement zone is at least about 2 feet by at least about 2 feet, for example, at least about 3 feet by at least about 3 feet, for example, at least two feet wide, for example at least about 2.5 feet wide, for example, at least about 3 feet wide. According to another embodiment, the movement zone is at least about three feet long, for example, at least about 4 feet long, for example, at least about 5 feet long. Other sizes and orientations are well within the skill of the artisan and are clearly contemplated within the instant disclosure.

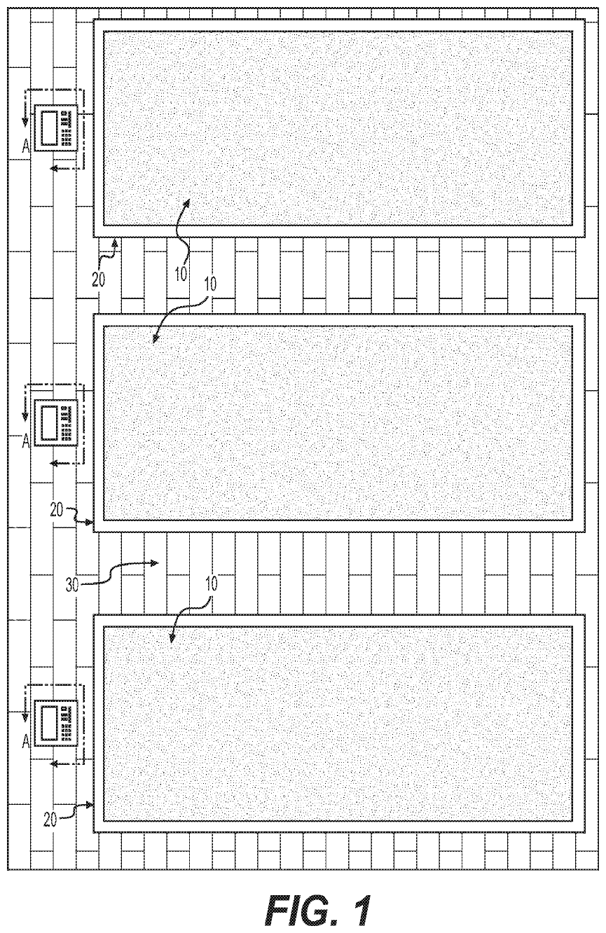

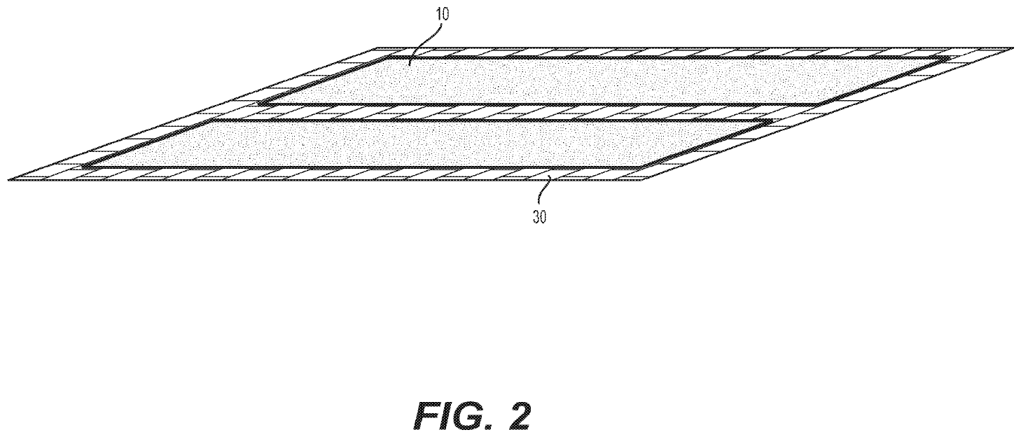

A system and method are described for carrying out exercise or yoga on a moving or vibrating surface. According to one embodiment as seen in FIG. 1, the surface of an exercise floor 30 comprises a series of movement zones 10 integrating into the exercise surface 30. In the particular embodiment shown in FIG. 1, the movement zones are substantially coplanar with the exercise surface 30. According to the embodiment shown, the movement zones are surrounded by a dampening component 20 that fixes the vibrating surface 10 within the exercise surface 30. A perspective view of the same movement zones 10 and exercise surface 30 can be seen in FIG. 2. The embodiment in FIG. 2 also shows the movement zones 10 to be substantially coplanar with the exercise surface 30.

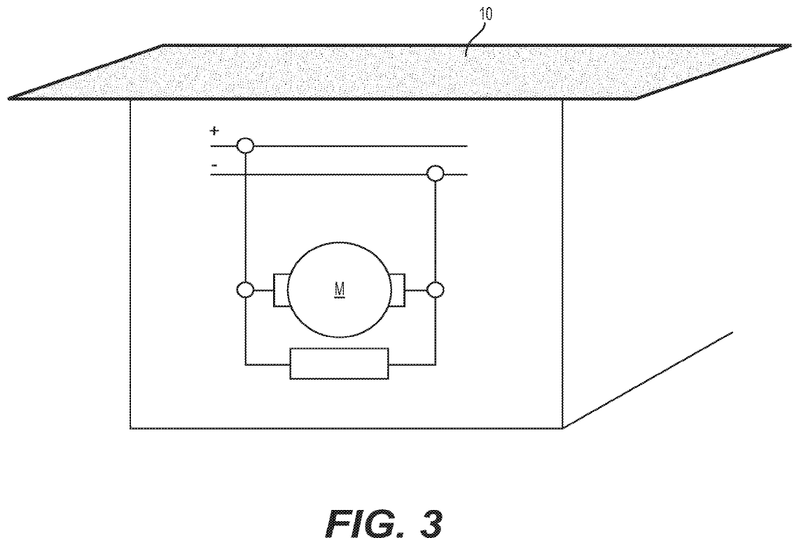

FIG. 3 shows a cut-away view of a movement zone 10, which may be flush mounted or that may be raised or recessed from the exercise surface 30. As seen in FIG. 3, the movement zone 10 sits atop and engages a motion generator, here a motor, 40. In the embodiment shown, the motor 40 causes the movement zone 10 to vibrate.

Any art recognized motion generator may be used in the system as described herein. An appropriate art recognized motion generator can be selected by the skilled artisan based upon the frequency and the amplitude of the movements that is desired. According to one embodiment, a motor can be used to create vibrations, both parallel and horizontal to the floor. According to another embodiment, an air compressor may be used to create vibrations or other motions within the movement zone.

According to another embodiment, the motions may be created by a series of air pockets below the movement zone through which air can be passed to cause a pattern of movements within the surface. According to this embodiment, the air pockets may be individual balloons that are inflated and deflated to create a movement pattern; Alternatively, the air pockets may be an interconnected series of balloons through which air can travel to create a pattern of movement in the exercise surface.

According to one embodiment, the movement zones 10 may be continuous with the surrounding exercise floor 30 and each movement zone 10 may comprise a flexible gusset as the dampening component 20. The use of a dampening component allows the movement zone 10 to move, while keeping the remaining exercise floor 30 stationary, In this embodiment, when the vibration system is not in use, the movement zones 10 would be stationary and make up a solid portion of the exercise floor. According to one embodiment, the dampening component 20 may be coplanar or slightly recessed from the height of the exercise surface to prevent interference with other uses of the exercise floor when the movement zones 10 are not in use.

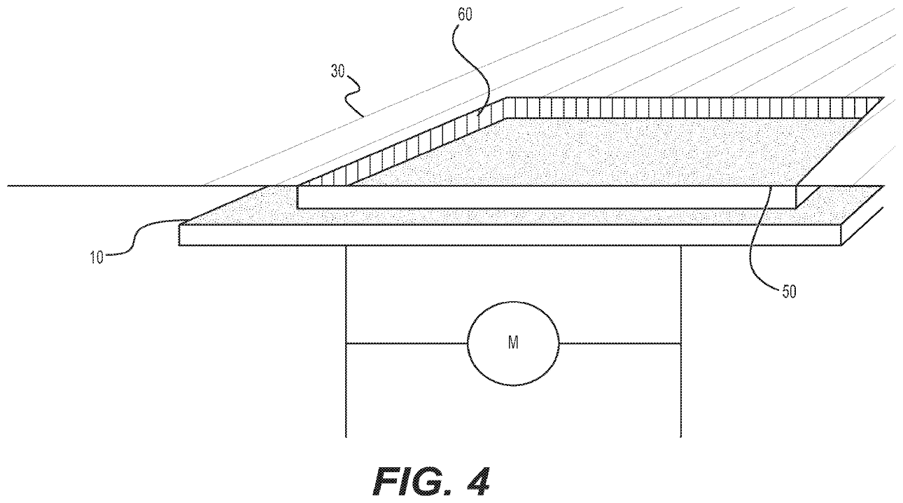

According to another embodiment, the movement zones 10 may be located below the bottom edge of the exercise surface 30. In this embodiment, the flooring system can be retracted, removed or disassembled, to provide the opening 50 to allow access to the movement zones 10. According to the embodiment seen in FIG. 4, the movement zone 10 may reside below the exercise floor 30. In the embodiment shown, the movement zone 10 extends below the floor and beyond the opening 50. According to one embodiment, a dampening component may be used between the movement zone 10 and the exercise floor 30 or the movement zone 10 can extend below and not in contact with the exercise floor 30 so an not to require a dampening component 20. As seen in FIG. 4, the motion generator 40 is located below the movement zone, in the subfloor.

According to the embodiment as seen in FIG. 4, the opening 50 has a lip 60 between the movement zone 10 and the exercise floor 30. According to one embodiment, the lip is prepared using a material that will prevent injury from occurring on contact with a user. In an alternative embodiment, the lip may be covered by a cap or other temporary material that will prevent contact between the user and the lip. According to one embodiment, in use, a floor section could be lifted and removed to expose the opening 50 and the movement zone 10. The user would then carry out an exercise or yoga session on the movement zone 10. Upon completion, the user will replace the floor section to cover the opening 50. According to this embodiment, the removable floor section can take any configuration. For example, it may be removed as a single panel using a handle or tool. It can be divided into smaller removable panels that may be removed by hand or by tool. The opening 50 and the removable floor section(s) may be configured to fit together in a stable and cooperative manner resulting in an exercise surface 30 that will be useful for exercises or classes not desiring the use of movement zones. The removable floor section and the lip of the opening 50 may include polymer stabilizers or gussets that prevent the removable floor section from moving under use conditions.

According to yet another embodiment, the flooring system may be an automatic retractable system. In this embodiment, the floor section would be retractable rather than being removable. According to one embodiment, the user would activate the retractable floor using a switch, remote, or other control system. A floor section would disengage and create the opening 50, as seen in FIG. 4. Any retraction design may be used, however according to one embodiment, the floor section would be released to fall below the exercise floor 30 and would be shuttled sideways away from the opening 50. When the opening 50 is clear, a vibration surface may be moved into position in the opening 50. The vibration surface could be elevated to be substantially coplanar with the exercise surface 30 via a mechanical device, a hydraulic system manual manipulation, or the like.

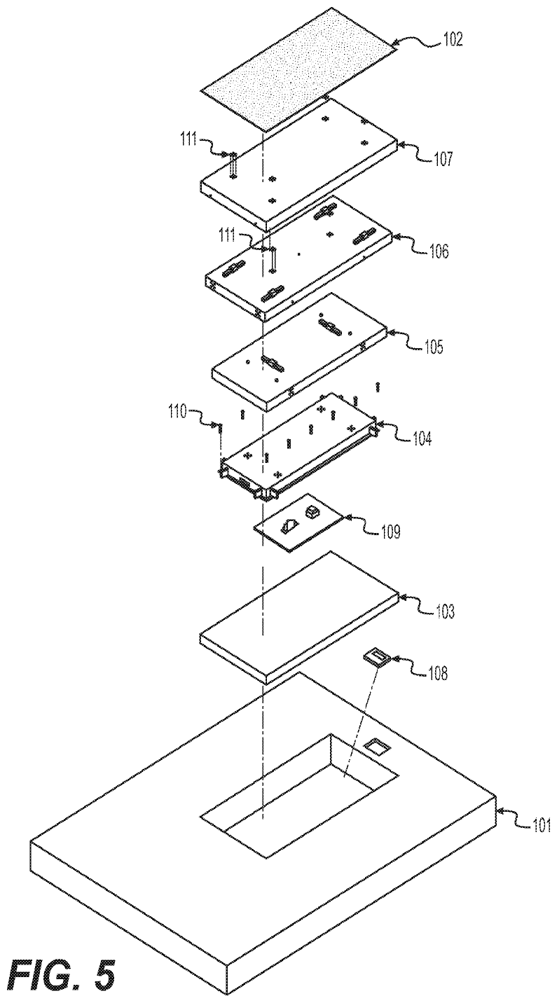

FIG. 5 shows an exploded view of one embodiment of an exercise system that is recessed into the floor of an exercise studio. In this embodiment, the exercise floor 101, has a recessed opening for receiving a series of components that make up the movement zone and are associated with a motion generator. As seen in FIG. 5, the movement zone includes an exercise surface 102 upon which a user would perform their exercise or mediation. According to the embodiment depicted, the exercise surface 102 overlays a platform assembly made up of four parts, an upper assembly 107, a middle platform assembly 106, a lower platform assembly 105, and a base platform assembly 104. While this embodiment describes a preferred four part assembly, other assemblies would be available to the skilled artisan and are considered within the scope of this invention.

Below the assembly, is a control panel 109 which includes controls both for a motion generator, e.g., a compressor and a logic control system for conveying instructions between the display panel 108 and the motion generator. According to the embodiment shown, the movement zone resides on a concrete foundation 103.

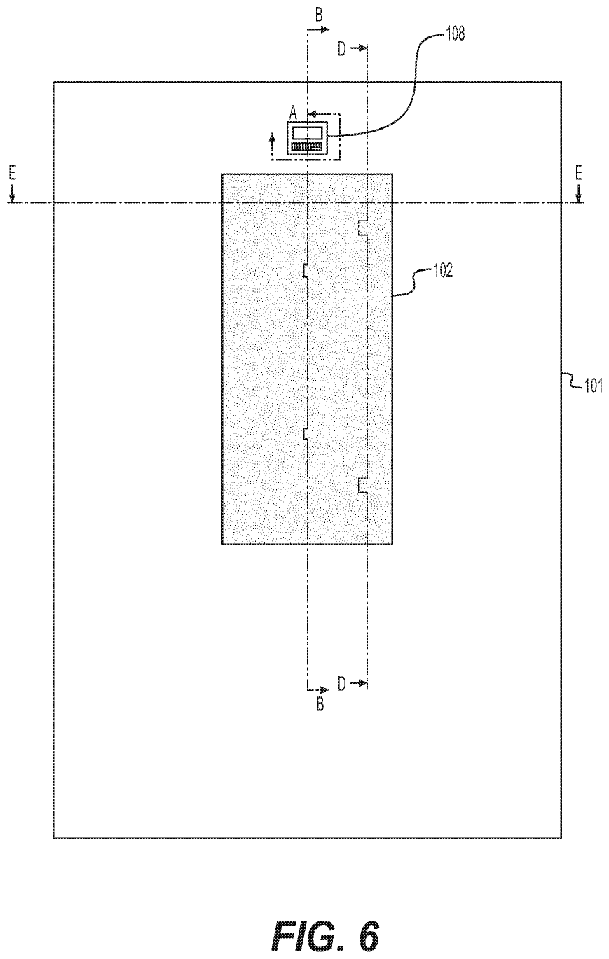

FIG. 6 illustrates one embodiment of the invention where the movement zone is flush with the exercise floor. In the embodiment shown, the controller 108 is also recessed into the floor.

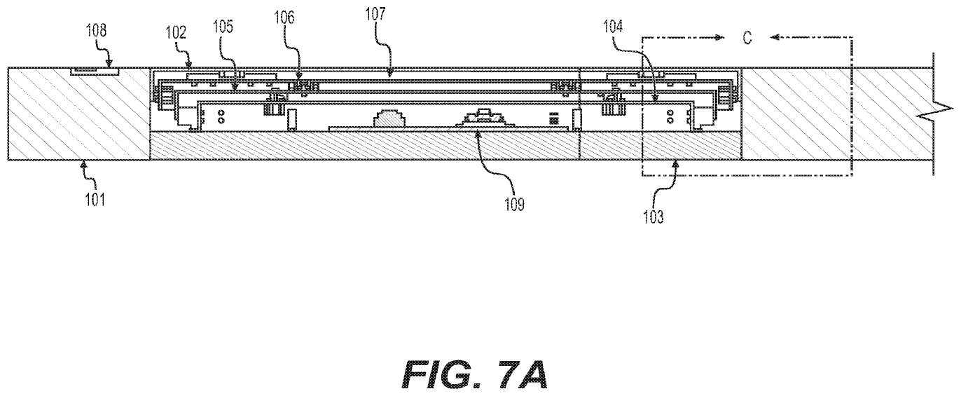

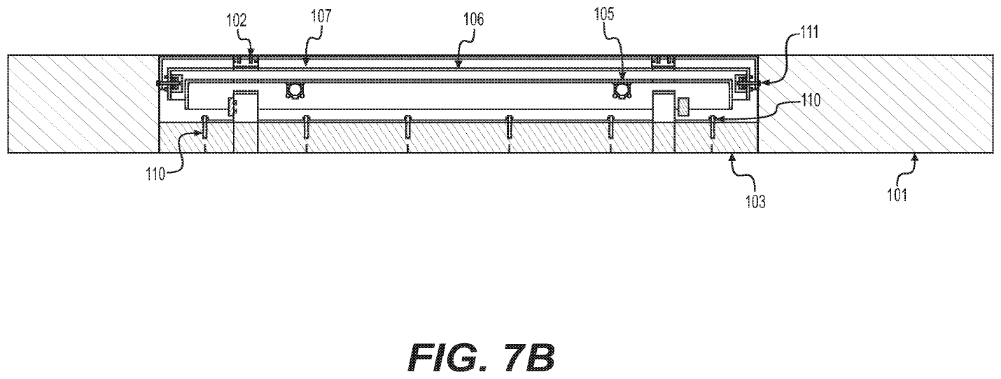

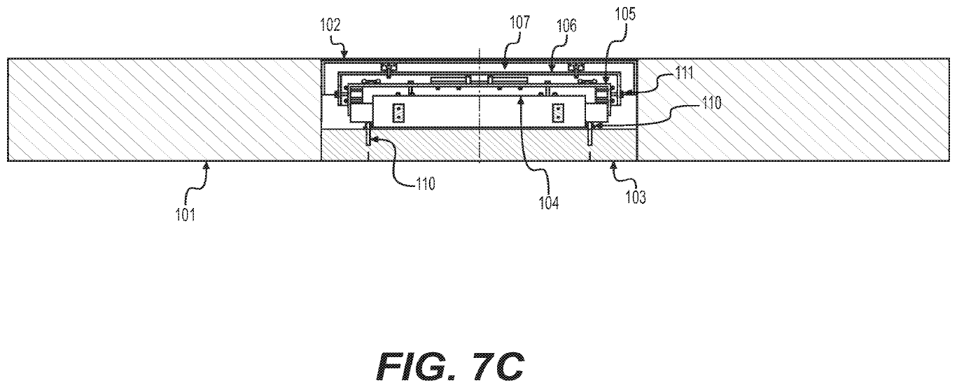

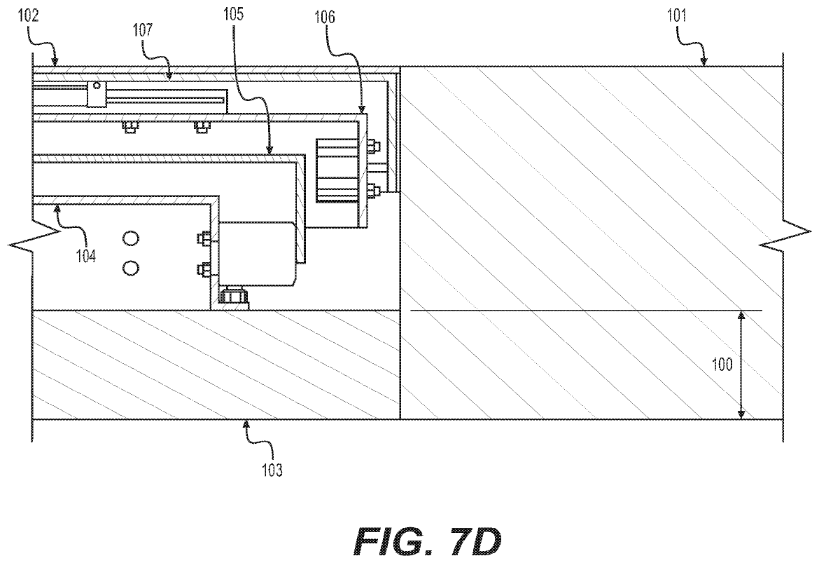

FIGS. 7A to 7D are cross sectional views of the exploded assembly of FIG. 5. FIG. 7A. is an enlarged view of the movement zone and floor through the section line B-B of FIG. 6. This view shows the system along the longest edge of the movement zone. As can be seen in FIG. 7A, the floor 101 is continuous with both the exercise surface 102 upon which a user would perform their exercise and the controller 108. Below the exercise surface, the control panel 109 rests upon the concrete foundation 103. The assembly upper platform assembly 107 is attached to the middle platform assembly 106, which is itself attached to the lower platform assembly 105. The lower platform assembly is connected to the base platform assembly 104 which is secured to the concrete foundation 104. As seen in FIG. 7B, through section line D-D of FIG. 6, the assembly plates 105 includes a set of actuators for connection to the compressed air. The attachment of assembly 104 to concrete base 103 can be seen in the cross-section seen in FIG. 7C. And a detailed view of the attachment of the assembly platforms can be seen in FIG. 7D.

Each of the assemblies include a set of actuator hoses, not shown that are connected to a compressed aft source which provides the motion to the assembly. Likewise, the assemblies could be connected to other motion generators to create the motion of the assembly plates. The number and placement of the actuators are well within the level of ordinary skill in the art.

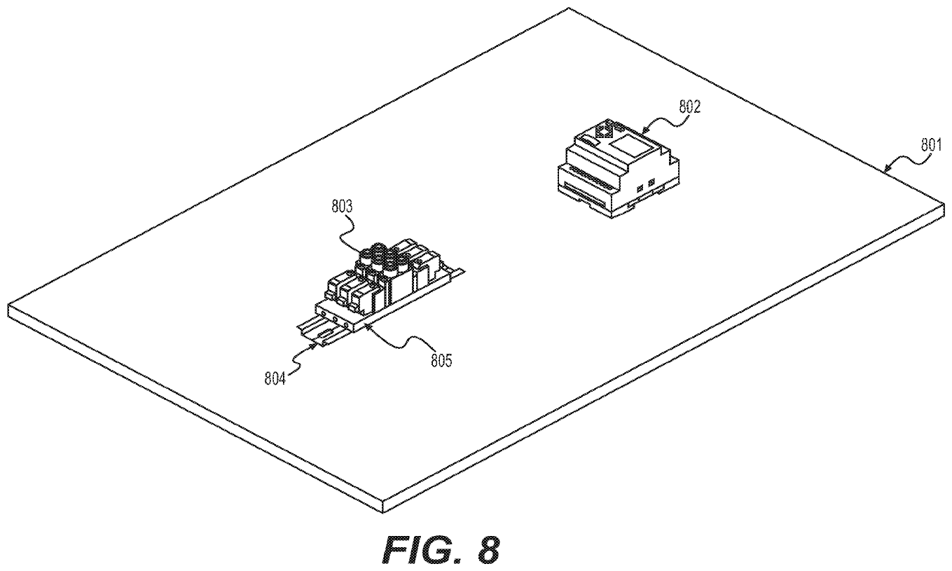

FIG. 8 an enlarged view of the control assembly 109 from FIG. 5. The control assembly is mounted to a plywood sheet 801. A solenoid valve 803 is mounted via rail 804 to the plywood 801. A logic controller 802 is also mounted to plywood base 108.

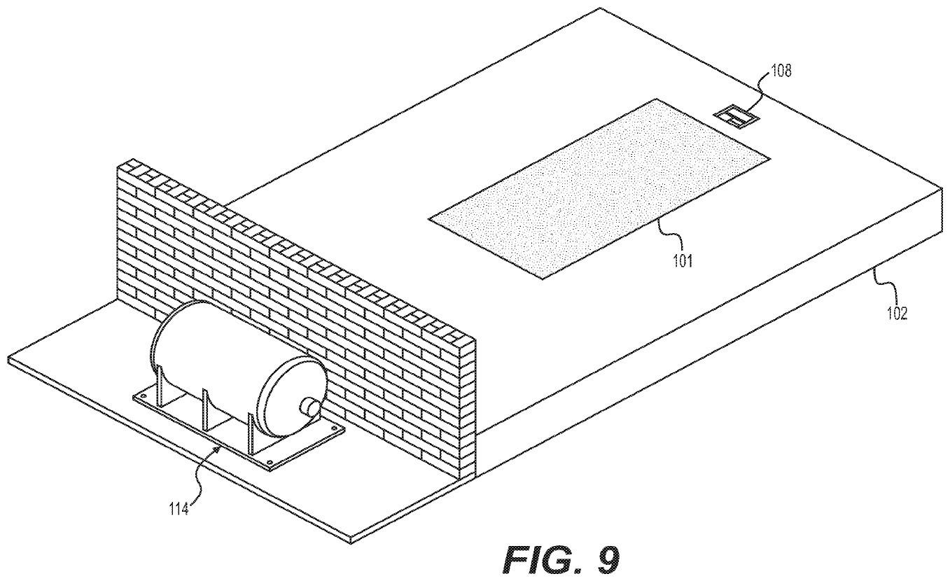

FIG. 9 illustrates one embodiment of a recessed movement zone and flooring system including a controller 108 and an air compressor 114 for providing air to the acutators which drive the motion of the exercise surface in the movement zone.

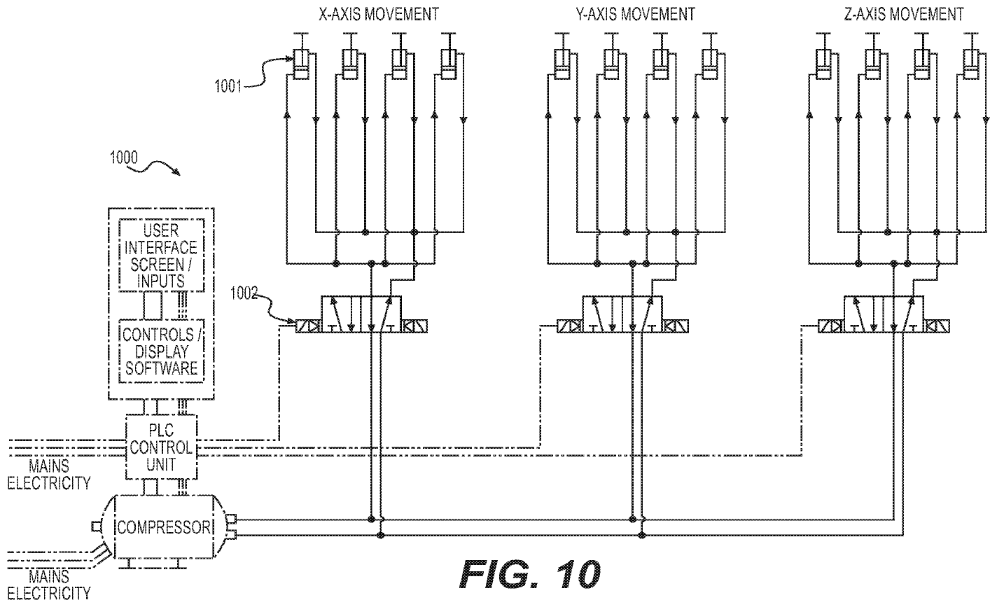

FIG. 10 illustrates an actuator system 1000 according to a preferred embodiment as described. The system 1000 uses a series of linear actuators 1001 and valves 1002 to control the movement of the assemblies 104, 105, 106, 107 in the movement zone. According to the embodiment shown, compressed air is fed through a series of valves 1002 to the linear actuators which provide the physical movement of the assemblies 104, 105, 106, 107. The linear actuators 1001 control the x, y and z movement of the assemblies. Based upon input from the control system, valves 1002 are opened allowing air to direct the desired actuator 1001 to cause movement of the assemblies in the desired movement patterns.

According to yet another embodiment, a yoga or exercise program can be carried out using a series of elevated vibration plates. According to this embodiment, the vibration plates may be securely attached into or onto an exercise floor or they may be portable plates in which individual units can be placed freely throughout the studio while participating in physical exercise including yoga, pilates, and the like. According to one embodiment, these vibration plates have a low profile, for example, less than 6 inches in height. According to this embodiment, the vibration plates may use a series of smaller motors, compressed air, or other motion generators. According to this embodiment, the user may be able to control the motors individually allowing them to vary the vibration along the movement zone. According to one embodiment, the raised vibration plates further comprise a skirt or guard that encircles the vibration plate to prevent injury during use.

Each of the embodiments described may be modified to replace a single vibration generator with a multitude of vibration generators to allow the user a more individualized experience. Construction of such a vibration plate or movement zone is well within the skill of the artisan.

This system can be controlled by any art recognized mechanism including but not limited to hard wiring, wireless/Bluetooth, radio frequency (RF), or other means that would be readily apparent to the skilled artisan. Likewise, at all appropriate positions, the mechanical or electrical control may be replaced with simple hand controls.

According to one embodiment, the vibration generators may be wired to physical switches or a switchboard system that allows starting, stopping and varying the vibration frequency and amplitude of the vibration generators. According to another embodiment, the vibration generators are controlled wirelessly via remote control. According to yet another embodiment, the vibration generators are controlled wirelessly or via Bluetooth using an app on a smart device.

According to one embodiment, the movement zones can be controlled collectively by an instructor teaching an exercise or yoga class. Alternatively, the movement zones can be controlled individually by the user. Finally, when multiple vibration generators are used, their control can likewise be collective or individual depending upon the control chosen. Movement zones as described can have multiple types of vibration control associated with each motion generator.

According to a preferred embodiment, the system would be controlled via an app that the user could download to their smart device. The software system would allow them to start, stop and change the vibrations from the vibration generator. The app can also be used to provide any or all of the following; retraction of a retractable floor; user control of either or both speed and power of vibration; saving and tracking of individual performances, including but not limited to, previous individual vibration plate settings, previous yoga or exercise classes, subjective and objective data from previous performances, agility, repetitions, strength progress and regression, and other individual preferences.

Data from such an app may be captured by the software system and would allow trending or tracking data on an individual basis, or trending and tracking combined data to provide objective benefits of using vibration during exercise or yoga.

While the system and methods as described herein are directed to exercise and yoga being carried out on the movement zones, the system may be installed and used in other areas that would benefit from vibrating plates, for example, physical therapy locations, gyms, professional athletic facilities, spas, and the like.

As used herein, “about” is meant to account for variations due to experimental error. All numerical measurements are understood to be modified by the word “about”, whether or not “about” is explicitly recited, unless specifically stated otherwise. Thus, for example, the statement “a distance of 10 meters” is understood to mean “a distance of about 10 meters.”

Although specific embodiments have been illustrated and described herein, it should be appreciated that any arrangement configured to achieve the same purpose may be substituted for the specific embodiments shown. This disclosure is intended to cover any and all adaptations or variations of various embodiments. Combinations of the above embodiments, and other embodiments not described herein, will be apparent to those of skill in the art upon reviewing the above description.

What is claimed:

1. A system for exercising, comprising:
a non-moving exercise surface;
a movement zone;
wherein the movement zone is integrated into the non-moving exercise surface.

2. The system of claim 1, wherein the exercise surface is a floor.

3. The system of claim 1, wherein the movement zone is sized and shaped like a yoga mat.

4. The system of claim 1, further comprising a motion generator to provide a pattern of movement to the movement zone.

5. The system of claim 4, wherein the motion generator comprises compressed air.

6. The system of claim 5, further comprising at least two actuators.

7. The system of claims 6, wherein the motion generator comprises at least one actuator in each of the x, y and z directions.

8. The system of claim 4, wherein the motion generator comprises a motor.

9. The system of claim 4. wherein the motion generator comprises a series or air pockets below the exercise surface.

10. The system of claim 1, wherein the exercise surface is a floor and the movement zone is coplanar with the floor.

11. The system of claim 10, wherein the movement zone comprises an exercise surface overlying an assembly that provides movement to the exercise surface.

12. The system of claim 11, wherein the assembly comprises at least one assembly platform that includes at least one actuator.

13. The system of claim 12, wherein the assembly comprises at least two assembly platforms that include at least one actuator.

14. An exercise system comprising
an exercise floor,
a movement zone coplanar with the exercise floor;
wherein the movement zone comprises
an exercise surface;
at least two assembly platforms that include actuators for controlling the directional movement of the platforms;
a motion generator; and
a base.

15. The system of claim 14, wherein the motion generator comprises an air compressor.

16. The system of claim 14, wherein the movement zone is at least about 2 feet wide and at least about 2 feet long.

17. The system of claim 14, wherein the exercise surface is coplanar with the exercise floor and the assembly platforms are located below the exercise surface.

18. A method of improving muscle strength comprising;
resting upon an exercise surface over a movement zone that can be caused to move;
inputting information to control the movement zone to create a desired pattern of motion;
carrying out a series of exercises on the exercise surface;
wherein the exercise surface is at least about 2 feet wide and 3 feet long.

19. The method of claim 18 14, wherein the movement zone is at least about 2 feet wide and at least about 4 feet long.

20. The method of claim 18, wherein the exercise surface is coplanar with a surrounding exercise floor.
